(19) United States
(12) Patent Application Publication
(10) Pub. No.: US 2016/0357479 A1
(43) Pub. Date: Dec. 8, 2016

(54) STORAGE CONTROL APPARATUS

(71) Applicant: FUJITSU LIMITED, Kawasaki-shi (JP)

(72) Inventors: Hiroshi Koarashi, Takaoka (JP); Shimpei Ogino, Nasushiobara (JP); Hitomi Akiyama, Kawasaki (JP); Takeshi Ueda, Kawasaki (JP); Kenji Higuchi, Kawasaki (JP); Meiu Naruse, Yokohama (JP); REISUKE NAKAGAWA, Inagi (JP); Hiroaki Konno, Nasushiobara (JP)

(73) Assignee: FUJITSU LIMITED, Kawasaki-shi (JP)

(21) Appl. No.: 15/170,039

(22) Filed: Jun. 1, 2016

(30) Foreign Application Priority Data
Jun. 8, 2015 (JP) 2015-115559

(51) Int. Cl. G06F 3/06

(52) U.S. Cl. CPC G06F 3/0644; G06F 3/0604; G06F 3/0673

(57) ABSTRACT

A storage control apparatus is provided that includes a storage unit and a control unit. The storage unit is configured to store management information indicating a formatting status of each of a plurality of partitions included in a storage area. The control unit is configured to perform a procedure including: upon receiving a write request to write first data to the storage area, determining whether a partition including a region to which the first data is to be written is formatted, based on the management information; and when the partition is unformatted, generating third data with a size that matches a size of the partition by combining the first data and predetermined second data, and writing the third data to the partition.

### CROSS-REFERENCE TO RELATED APPLICATION

This application is based upon and claims the benefit of priority of the prior Japanese Patent Application No. 2015-115559, filed on Jun. 8, 2015, the entire contents of which are incorporated herein by reference.

### FIELD

The embodiments discussed herein are related to a storage control apparatus.

### BACKGROUND

Disk arrays that provide faster data access and greater capacity are widely used. A disk array includes multiple storage devices (hard disk drives (HDDs), solid state drives (SSDs), and the like) that are combined for redundancy by using the redundant array of independent disks (RAID) technology. In the disk array, logical storage areas called logical units (LUs) are created, and the physical storage areas of the storage devices are allocated to the logical units. Each LU is identified by a logical unit number (LUN). A logical storage area corresponding to a LUN is often called a LUN area.

A LUN area is set by a controller connected to the disk array. When assigning a LUN in a disk array, the controller formats a LUN area corresponding to the LUN. In doing so, the controller writes null (zero) data and a block checking character (BCC) to a sector of a storage device corresponding to the LUN area.

In recent years, the capacity of individual storage devices has been increased. This has resulted in an increase in the time taken to perform formatting upon starting operations. Thus, techniques that make it possible to perform formatting during operations have been studied.

For example, there has been a proposed technique that writes data to a disk if an area specified in a write request has been initialized. If the area has not been initialized, data is saved into the cache until completion of initialization, and is written from the cache to the disk upon completion of initialization. There has also been disclosed a technique that manages information indicating whether formatting has been performed, by using a bitmap memory. If the entire area to be accessed has been formatted, a disk access is made. If not, formatting is performed.

See, for example, Japanese Laid-open Patent Publications No. 2005-11317 and No. 2003-29934.

The techniques described above are a method that, when formatting has not been performed, temporarily saves write data, and formats a target area. Accordingly, after the target area is formatted by writing data such as null data or the like thereto, data specified in a write request is written to the target area.

If formatting may be performed during operations, there is no need to wait for operations to start until formatting of the disk array completes. However, while formatting is being performed, processing load is placed on resources such as the disk array, the controller, and the like. This might affect other operations, such as slowing down data reading and writing.

### SUMMARY

According to one aspect, there is provided a storage control apparatus including: a memory configured to store management information indicating a formatting status of each of a plurality of partitions included in a storage area; and a processor configured to perform a procedure including: upon receiving a write request to write first data to the storage area, determining whether a partition of the plurality of partitions that includes a region to which the first data is to be written is formatted, based on the management information; and when the partition is unformatted, generating third data with a size that matches a size of the partition by combining the first data and predetermined second data, and writing the third data to the partition.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a storage system according to a first embodiment;

FIG. 2 illustrates an example of a storage system according to a second embodiment;

FIG. 3 illustrates an example of the hardware of a server according to the second embodiment;

FIG. 4 illustrates an example of functions of a controller according to the second embodiment;

FIG. 5 illustrates an example of a LUN management table according to the second embodiment;

FIG. 6 illustrates an example of updating a formatting management table according to the second embodiment;

FIG. 7 illustrates an example of a copy process (partition size of copy source<partition size of copy destination) according to the second embodiment;

FIG. 8 illustrates an example of a copy process (partition size of copy source>partition size of copy destination) according to the second embodiment;

FIG. 9 is a flowchart illustrating the flow of a LUN creation process according to the second embodiment;

FIG. 10 is a first flowchart illustrating the flow of a WRITE process according to the second embodiment;

FIG. 11 is a second flowchart illustrating the flow of the WRITE process according to the second embodiment;

FIG. 12 is a flowchart illustrating the flow of a READ process according to the second embodiment;

FIG. 13 is an explanatory diagram illustrating application to OPC/QuickOPC;

FIG. 14 is a first explanatory diagram illustrating application to SnapOPC/SnapOPC+;

FIG. 15 is a second explanatory diagram illustrating application to SnapOPC/SnapOPC+;

FIG. 16 is a third explanatory diagram illustrating application to SnapOPC/SnapOPC+; and

FIG. 17 is an explanatory diagram illustrating application to EC.

### DESCRIPTION OF EMBODIMENTS

Hereinafter, several embodiments will be described with reference to the accompanying drawings. Like reference numerals refer to like elements throughout, and a description of like elements will not be repeated.

### (1) First Embodiment

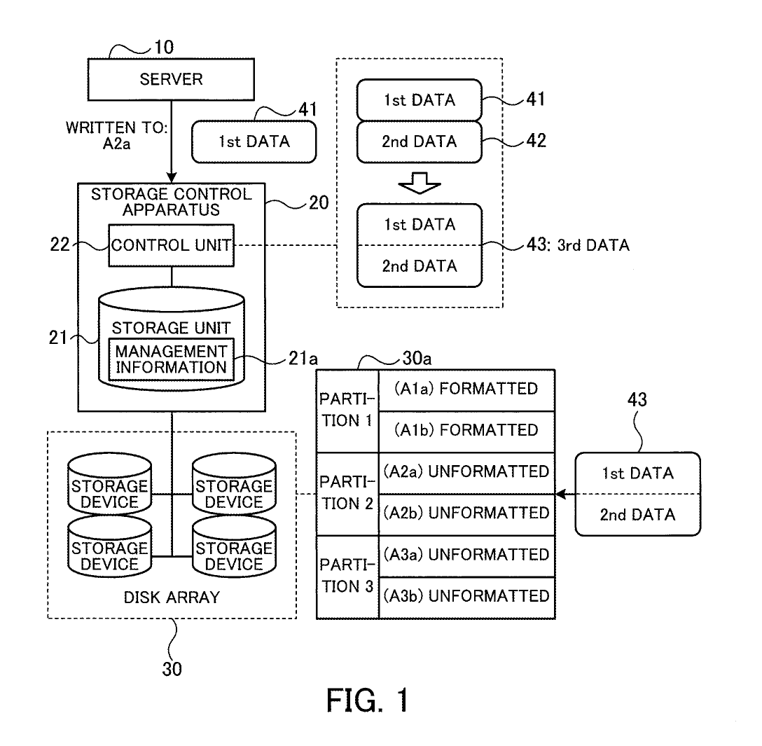

A first embodiment will be described with reference to FIG. 1. The first embodiment provides a mechanism that eliminates the need to perform formatting in advance by writing data specified in a write request to an unformatted region. According to this mechanism, it is possible to prevent an increase in the time taken to perform formatting and processing load associated with the formatting. FIG. 1 illustrates an example of a storage system according to the first embodiment.

The storage system of FIG. 1 includes a server 10, a storage control apparatus 20, and a disk array 30. The server 10 requests the storage control apparatus 20 to write data to the disk array 30. The server 10 also requests the storage control apparatus 20 to read data from the disk array 30. The disk array 30 is, for example, a RAID device including a plurality of storage devices (such as HDDs, SSDs, and the like) that are combined for redundancy by using the RAID technology. Operations of the disk array 30 are controlled by the storage control apparatus 20.

The storage control apparatus 20 includes a storage unit 21 and a control unit 22.

The storage unit 21 is a volatile storage device such as a random access memory (RAM) and the like, or is a non-volatile storage device such as an HDD, a flash memory, and the like. The control unit 22 is a processor such as a central processing unit (CPU), a digital signal processor (DSP), and the like. Alternatively, the control unit 22 may be an electronic circuit such as an application specific integrated circuits (ASIC), a field programmable gate array (FPGA), and the like. The control unit 22 executes a program stored in the storage unit 21 or other memories, for example.

The storage unit 21 stores management information 21a indicating the formatting status of each of a plurality of partitions included in a storage area 30a.

The storage area 30a is a LUN area, for example. The partitions are a plurality of sub-areas included in the LUN area. Each partition includes a plurality of blocks. The storage area 30a of FIG. 1 includes a partition 1, a partition 2, and a partition 3. The partition 1 includes two blocks identified by addresses A1a and A1b. The partition 2 includes two blocks identified by addresses A2a and A2b. The partition 3 includes two blocks identified by addresses A3a and A3b. The number of blocks included in each partition (the partition size) may be three or more.

The management information 21a is information indicating, for each partition of the storage area 30a, whether the partition is formatted. For example, the management information 21a may be represented by a bitmap including a bit value for each partition, in which the bit value “0” indicates that the partition is formatted, and the bit value “1” indicates that the partition is unformatted.

Upon receiving a write request to write first data 41 to the storage area 30a, the control unit 22 determines whether a partition including a region to which the first data 41 is to be written is formatted, based on the management information 21a. Further, if the partition is unformatted, the control unit 22 generates third data 43 with a size that matches the size of the partition, by combining the first data 41 and predetermined second data 42. Then, the control unit 22 performs control to write the third data 43 to the partition.

In the following, a further description will be given of the example of FIG. 1.

In the example of FIG. 1, the server 10 requests the storage control apparatus 20 to write the first data to the address A2a of the storage area 30a. Upon receiving this write request, the control unit 22 determines whether the partition 2 including a region at the address A2a is formatted, by referring to the management information 21a. In the example of FIG. 1, the partition 2 is unformatted. In this case, the control unit 22 generates third data 43 by combining the first data 41 and the second data 42.

The second data 42 is data, such as null data and the like, that is written to the storage area 30a upon formatting. The second data 42 is data with a size that is adjusted to fill a region in the partition 2 to which the first data 41 is not written. In this example, if the first data 41 is written to the region at the address A2a, the region at the address A2b remains unformatted. In this case, the control unit 22 prepares the second data 42 to fill the region at the address A2b, and generates third data 43 by combining the first data 41 and the second data 42.

The control unit 22 writes the thus generated third data 43 to the partition 2. Then, the control unit updates the management information 21a to change the formatting status of the partition 2 to “formatted”. When the third data 43 is written to the partition 2, the partition 2 has data written therein. According to this method, there is no need to perform a formatting process that writes null data or the like to the region at the address A2a before writing the first data 41 to the region at the address A2a. Therefore, it is possible to reduce processing time and processing load.

The above is a description of the first embodiment.

### (2) Second Embodiment

The following describes a second embodiment. The second embodiment provides a mechanism that eliminates the need to perform formatting in advance by writing data specified in a write request to an unformatted region. According to this mechanism, it is possible to prevent an increase in the time taken to perform formatting and processing load associated with the formatting.

(2-1) System

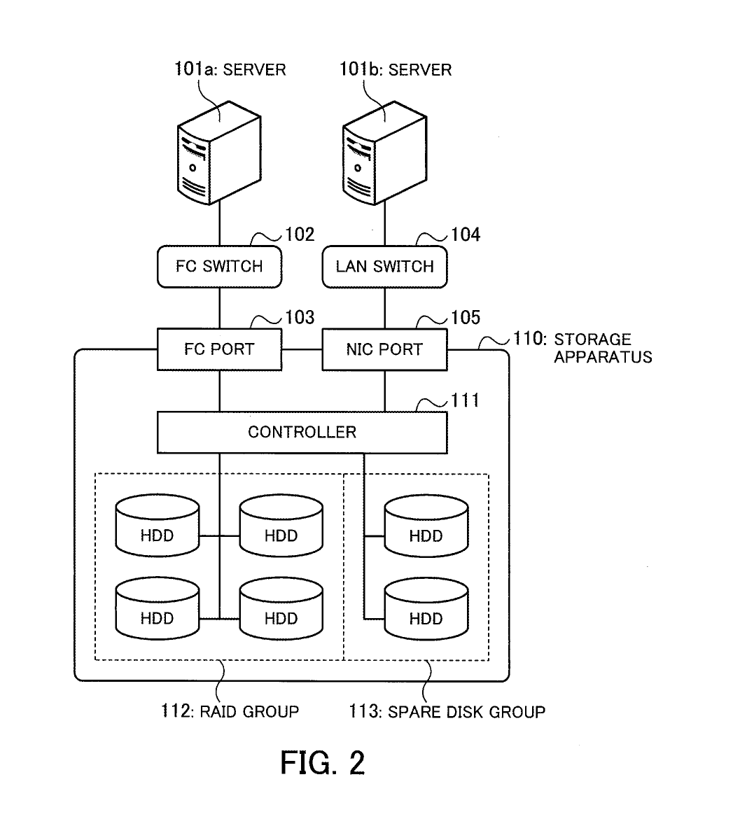

A storage system according to the second embodiment will be described with reference to FIG. 2. FIG. 2 illustrates an example of the storage system according to the second embodiment.

The storage system of FIG. 2 includes servers 101a and 101b, a Fibre Channel (FC) switch 102, an FC port 103, a local area network (LAN) switch 104, a network interface card (NIC) port 105, and a storage apparatus 110. The FC port 103 is an interface that connects the FC switch 102 and the storage apparatus 110. The NIC port 105 is an interface that connects the LAN switch 104 and the storage apparatus 110.

The servers 101a and 101b are host computers that request the storage apparatus 110 to write data and read data. In the example of FIG. 2, only one server 101a is connected to the FC switch 102 for convenience of explanation. However, a plurality of host computers may be connected to the FC switch 102. These host computers are connected to the FC port 103 of the storage apparatus 110 via the FC switch 102 so as to form a storage area network (SAN).

Further, in the example of FIG. 2, only one server 101b is connected to the LAN switch 104 for convenience of explanation. However, a plurality of host computers may be connected to the LAN switch 104. These host computers are connected to the NIC port 105 of the storage apparatus 110 via the LAN switch 104 so as to use the storage apparatus 110 as network attached storage (NAS).

Note that the server 101a may use the LAN in order to transmit and receive I/Os for managing the storage apparatus 110. In this case, the server 101a is connected to not only the FC switch 102 but also the LAN switch 104.

The storage apparatus 110 includes a controller 111, a RAID group 112, and a spare disk group 113. The controller 111 controls operations of the RAID group 112 and the spare disk group 113. The RAID group 112 is a disk array including a plurality of HDDs that are combined for redundancy by using the RAID technology. LUN areas are set in the RAID group 112. Note that the RAID group 112 may include both HDDs and SSDs.

The LUN areas are set by the controller 111. When assigning a LUN to a LUN area that is set in the RAID group 112, the controller 111 determines whether to format the LUN area. That is, as will be described below, the controller 111 does not need to perform formatting when assigning a LUN. In the case of performing formatting, the controller 111 writes null data and a BCC to a sector of an HDD corresponding to the LUN area that is set. On the other hand, in the case of not performing formatting, the controller 111 assigns a LUN to the unformatted LUN area.

The spare disk group 113 is a group of HDDs not included in the RAID group 112. The HDDs of the spare disk group 113 are used for backing up data stored in a LUN area of the RAID group 112, or for other purposes, for example. Note that the HDDs of the spare disk group 113 may include an HDD that is used as an alternative HDD in case of a failure of an HDD of the RAID group 112.

In response to a READ request received from the server 101a or 101b, the controller 111 reads data from a LUN area. When reading the data from a location specified in the READ request, the controller 111 checks the consistency between the data and a BCC stored in a sector of the HDD, in order to guarantee the data quality. If the consistency is confirmed, the controller 111 responds with the read data to the server 101a or 101b (READ process).

Further, in response to a WRITE request received from the server 101a or 101b, the controller 111 writes data to a LUN area. In this step, the controller 111 reads old data and a BCC from a location specified in the WRITE request and checks the consistency. If the consistency is confirmed, the controller 111 performs an XOR (exclusive or) operation using the read BCC and write data, and thereby generates a BCC for the write data. Then, the controller 111 writes the write data and the BCC to the location specified in the WRITE request (WRITE process).

In the case where a READ request or a WRITE request is received, if there is a consistency between data and its BCC, the controller 111 is able to successfully complete a READ process or a WRITE process. However, in some cases such as when factory settings are used, there is not a consistency between data recorded in each sector of the HDD and its BCC. Formatting is a process to ensure the consistency.

As the capacity of HDDs has increased, the time taken to perform formatting has increased. Therefore, if formatting is performed before starting operations, it takes long time to start operations. If formatting is performed in the background, the processing load increases due to the formatting, which might result in adverse effects such as a delay in responding to an access request.

In the case of performing a WRITE process after formatting, an operation for writing null data and a BCC, an operation for checking the consistency, and an operation for rewriting with write data are performed sequentially, resulting in a redundant process. This redundant process is one of the factors of increasing the processing load. If a function is provided that ensures the consistency described above without performing these three steps of operations of writing, reading, and writing, it is possible to eliminate the need to perform formatting before starting operations, while preventing an increase in processing load during operations.

The storage apparatus 110 according to the second embodiment provides a function for eliminating the redundant process described above, reducing the time taken to start operations, and preventing a reduction in performance during operations due to a background process. This function may be highly effective when migrating data from an old product to a new product, when restoring data from a tape medium to a newly added HDD, when copying data in the background, and in some other events, for example.

The storage apparatus 110 described above will be further described below.

(2-2) Hardware

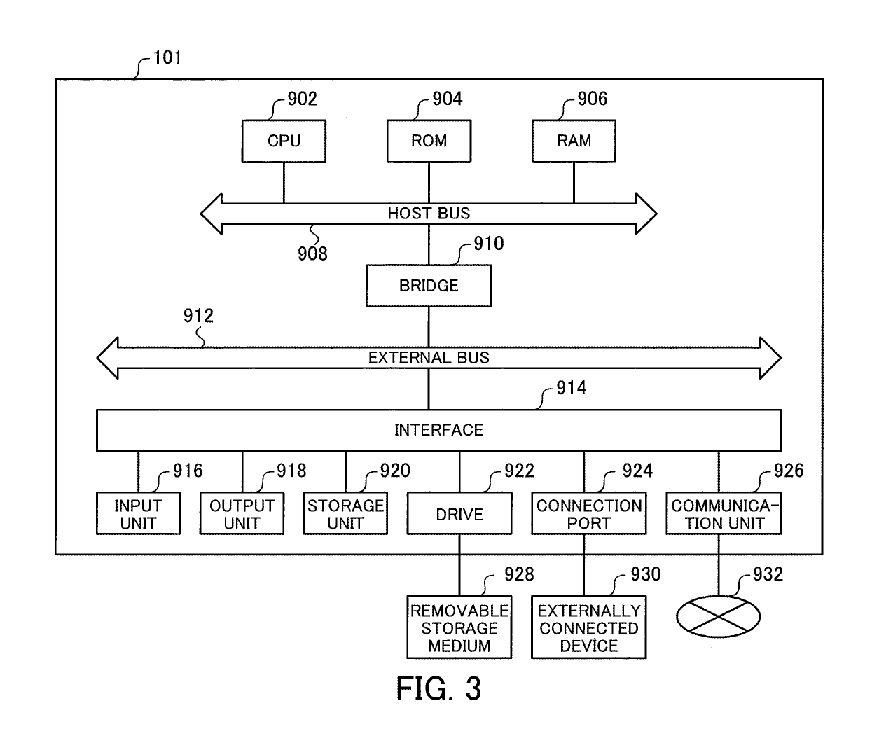

In the following, the hardware of the servers 101a and 101b will be described with reference to FIG. 3.

FIG. 3 illustrates an example of the hardware of a server according to the second embodiment.

The functions of the servers 101a and 101b may be implemented using the hardware resources illustrated in FIG. 3, for example. That is, the functions of the servers 101a and 101b are implemented by controlling the hardware illustrated in FIG. 3 using a computer program.

As illustrated in FIG. 3, the hardware mainly includes a CPU 902, a read only memory (ROM) 904, a RAM 906, a host bus 908, and a bridge 910. The hardware further includes an external bus 912, an interface 914, an input unit 916, an output unit 918, a storage unit 920, a drive 922, a connection port 924, and a communication unit 926.

The CPU 902 serves as, for example, an arithmetic processing unit or a control device, and controls all or part of the operations of the components in accordance with various programs recorded in the ROM 904, the RAM 906, the storage unit 920, and a removable storage medium 928. The ROM 904 is an example of a storage device that stores programs to be read by the CPU 902, data used for computation, and the like. The RAM 906 temporarily or permanently stores, for example, a program to be read by the CPU 902, various parameters that change when the program is executed, and the like.

These components are connected to each other via the host bus 908 capable of high speed data transmission. The host bus 908 is connected to the external bus 912 having a relatively low data transmission speed via the bridge 910, for example. The input unit 916 may be, for example, a mouse, a keyboard, a touch panel, a button, a switch, a lever, or the like. Further, the input unit 916 may be a remote controller capable of transmitting control signals using infrared rays or other electronic waves.

The output unit 918 may be, for example, a display device such as a cathode ray tube (CRT), a liquid crystal display (LCD), a plasma display panel (PDP), an electro-luminescence display (ELD), and the like. Further, the output unit 918 may be an audio output device such as a speaker, a headphone, and the like, or may be a printer. That is, the output unit 918 is a device capable of visually or audibly outputting information.

The storage unit 920 is a device for storing various types of data. The storage unit 920 may be, for example, a magnetic storage device such as an HDD and the like. Further, the storage unit 920 may be a semiconductor storage device (such as an SSD, a RAM disk, and the like), an optical storage device, a magneto-optical storage device, or the like.

The drive 922 is a device that reads information recorded in the removable storage medium 928 as a detachable storage medium, or writes information to the removable storage medium 928. The removable storage medium 928 may be, for example, a magnetic disk, an optical disc, a magneto-optical disk, a semiconductor memory, or the like.

The connection port 924 is a port for connecting an externally connected device 930, such as a universal serial bus (USB) port, an IEEE1394 port, a small computer system interface (SCSI), an RS-232C port, an optical audio terminal, and the like. The externally connected device 930 may be a printer or the like, for example.

The communication unit 926 is a communication device for connection to a network 932. The communication unit 926 may be, for example, a communication circuit for a wired or wireless LAN, a communication circuit for a wireless USB (WUSB), a communication circuit and a router for optical communication, a communication circuit and a router for an asymmetric digital subscriber line (ADSL), a communication circuit for a cellular phone network, or the like. The network 932 connected to the communication unit 926 is a network connected with a wire or wirelessly, and includes, for example, the Internet, a LAN, a broadcasting network, a satellite communication network, or the like.

The above is a description of the hardware of the servers 101a and 101b. Note that the functions of the storage apparatus 110 and the storage control apparatus 20 of the first embodiment may also be implemented using at least part of the hardware resources illustrated in FIG. 3.

(2-3) Functions of Controller

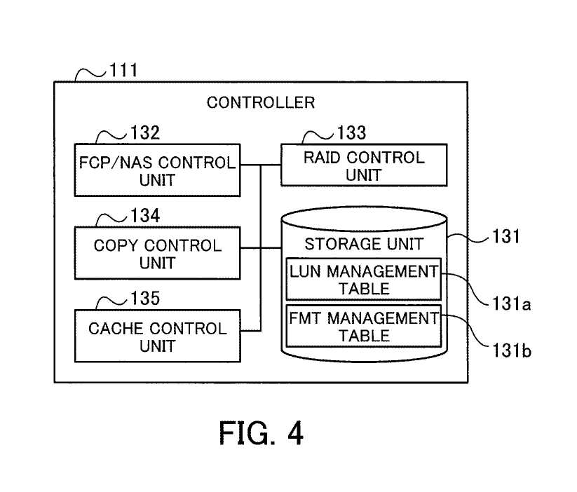

In the following, the functions of the controller 111 will be described with reference to FIG. 4. FIG. 4 illustrates an example of functions of the controller 111 according to the second embodiment.

The controller 111 includes a storage unit 131, a Fibre Channel Protocol (FCP)/NAS control unit 132, a RAID control unit 133, a copy control unit 134, and a cache control unit 135.

Note that the storage unit 131 is a volatile storage device such as a RAM and the like, or a non-volatile storage device such as an HDD, a flash memory, and the like. Each of the FCP/NAS control unit 132, the RAID control unit 133, the copy control unit 134, and the cache control unit 135 is a processor such as a CPU, a DSP, and the like. Alternatively, each of the FCP/NAS control unit 132, the RAID control unit 133, the copy control unit 134, and the cache control unit 135 may be an electronic circuit such as an ASIC, an FPGA, and the like. The FCP/NAS control unit 132, the RAID control unit 133, the copy control unit 134, and the cache control unit 135 execute programs stored in the storage unit 131 or other memories, for example.

The storage unit 131 includes a storage area for storing information of a LUN management table (TBL) 131a and an FMT management table (TBL) 131b.

LUN Management Table 131a

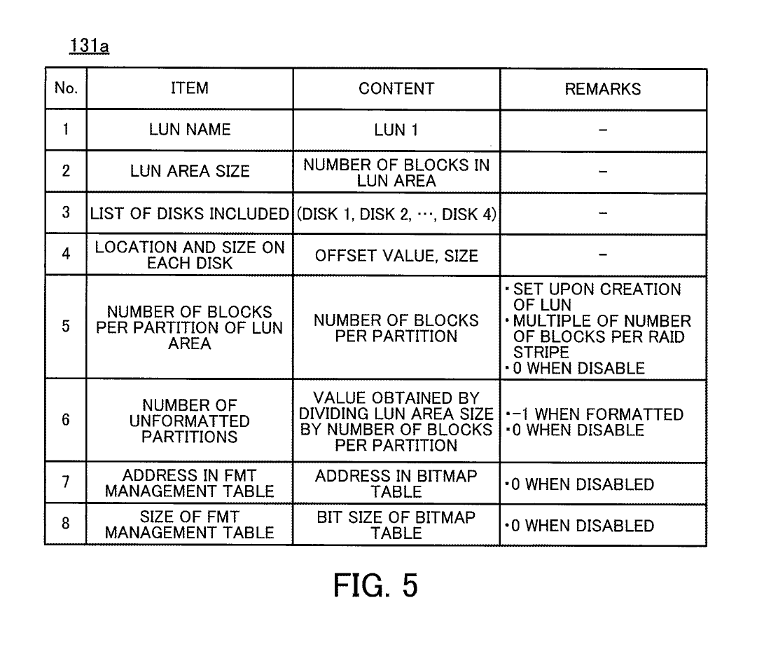

As illustrated in FIG. 5, the LUN management table 131a includes information on the LUN name, the LUN area size, a list of disks included, and the location and size on each disk. The LUN management table 131a further includes information on the number of blocks per partition of the LUN area, the number of unformatted partitions, the address in the FMT management table 131b, and the size of the FMT management table 131b. Note that FIG. 5 illustrates an example of the LUN management table 131a according to the second embodiment.

The LUN name is the name assigned to a LUN area managed by the LUN management table 131a. The LUN area size indicates the number of blocks included in the LUN area. The list of disks included is a list of HDDs (for example, a list of names assigned to HDDs) having physical storage areas corresponding to the LUN area created as a logical unit. The location and size on each disk indicates the location (represented by an OFFSET value, for example) and size on each HDD where the LUN area is set.

The number of blocks per partition of the LUN area indicates how many blocks are included in each partition. Each LUN area includes a plurality of partitions. Each partition includes a plurality of blocks. Thus, the LUN management table 131a stores information on the number of blocks indicating the size of a partition. The number of blocks is set when creating a LUN area.

Further, the number of blocks per partition of the LUN area is set to n times (n is an integer equal to or greater than 2) the number of blocks per RAID stripe. The size of a RAID stripe varies depending on the type of HDD and the number of HDDs included in the RAID group 112. Therefore, the number of blocks per partition of the LUN area is set in units of the number of blocks per RAID stripe. Note that since the LUN management table 131a becomes excessively large if a RAID stripe is used as a unit, it is preferable to set the number to a multiple thereof. When the technique according to the second embodiment is not applied due to operational reasons (when disabled), the value is set to 0.

The number of unformatted partitions is set to a value obtained by dividing the size of the LUN area by the number of blocks per partition, as an initial value. When partitions are formatted, the value is decremented by the number of formatted partitions. The initial value is the total number of partitions included in the LUN area. Then, the initial value is decremented by 1 for each partition that is formatted, so that the current number of unformatted partitions is obtained. Note that when the technique according to the second embodiment is not applied due to operational reasons (when disabled), the value is set to 0.

The address in the FMT management table indicates the address in a bitmap table as the substance of the FMT management table 131b. As will be described below, the bitmap table is a table including an array of bits, each bit corresponding to a partition in the LUN area. The bit value of each bit indicates the formatting status. For example, a bit value indicates an unformatted state, and a bit value “0” indicates a formatted state.

The size of the FMT management table indicates the number of bits (bit size) included in the bitmap table. When the technique according to the second embodiment is not applied due to operational reasons (when disabled), both the address in the FMT management table and the size of the FMT management are set to 0.

FMT Management Table 131b

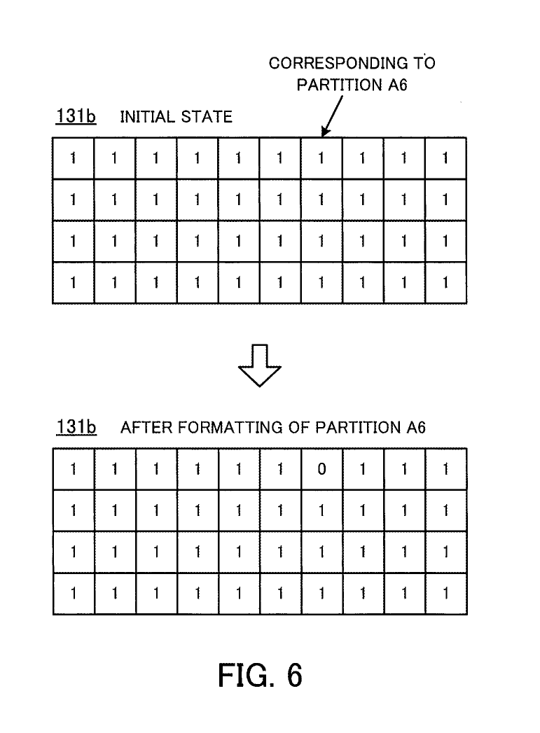

As illustrated in FIG. 6, the FMT management table 131b is a bitmap table including an array of bit values. Each bit corresponds to a partition. Note that FIG. 6 illustrates an example of updating a formatting management table according to the second embodiment. The example of FIG. 6 illustrates a transition from the initial state in which all the bits are set to the bit value 1 (unformatted state) to a state in which a partition corresponding to the bit at an address A6 is formatted.

The relationship between a position on the bitmap and a partition may be specified by referring to the address in the FMT management table indicated in the LUN management table 131a described above. For example, when a partition corresponding to the bit at the address A6 on the bitmap is formatted, the bit value of the bit at the address A6 is changed from the bit value 1 indicating an unformatted state to the bit value 0. Similarly, when another partition is formatted, the bit value of a bit corresponding to the other partition is changed to 0.

Now, FIG. 4 is referred to again.

The FCP/NAS control unit 132 performs I/O control of FCP and NAS to the LUN area. Fibre Channel uses Fibre Channel Protocol (FCP), and transports SCSI commands. On the other hand, NAS transports file sharing commands for Network File System (NFS), Common Internet File System (CIFS), and the like. The FCP/NAS control unit 132 exchanges commands with the servers 101a and 101b in accordance with these protocols.

The RAID control unit 133 controls operations of the RAID group 112. The copy control unit 134 controls copying of data between LUN areas. The cache control unit 135 performs cache control for enabling high-speed processing using a cache memory (not illustrated) when executing an I/O to the RAID group 112.

The cache memory is a storage device that allows faster data reading and writing than a LUN area of the RAID group 112. The cache memory may be, for example, a non-volatile memory or a volatile memory connected to the controller 111.

For example, upon receiving a WRITE request from the server 101a, the cache control unit 135 writes data specified in the WRITE request to the cache memory. Then, upon completion of the writing to the cache memory, the cache control unit 135 returns a completion response to the server 101a. Further, the cache control unit 135 writes the data stored in the cache memory to the LUN area upon a predetermined event.

Further, upon receiving a READ request from the server 101a, the cache control unit 135 determines whether data to be read is in the cache memory. If data to be read is in the cache memory, the cache control unit 135 reads the data from the cache memory and responds with the data to the server 101a. If data to be read is not in the cache memory, the cache control unit 135 reads the data from a LUN area and responds with the data to the server 101a.

Example of Copy Process

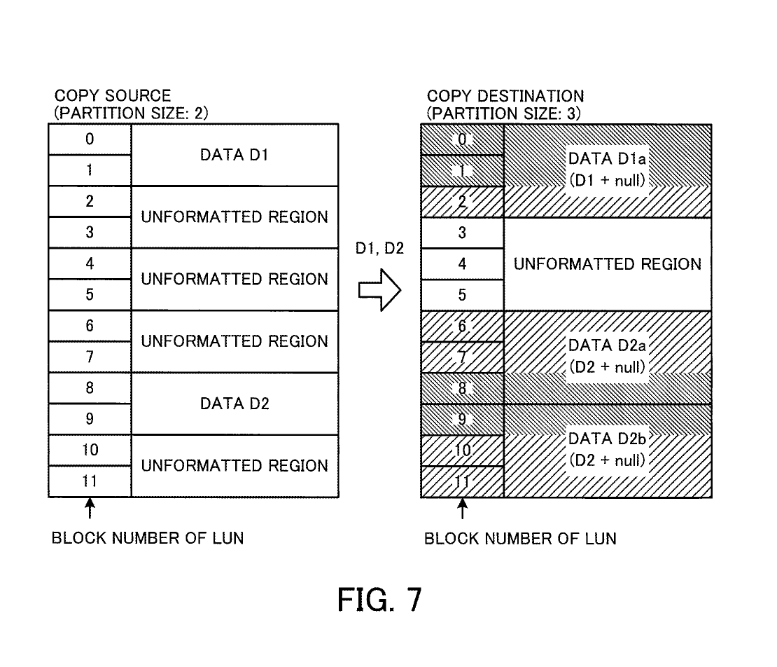

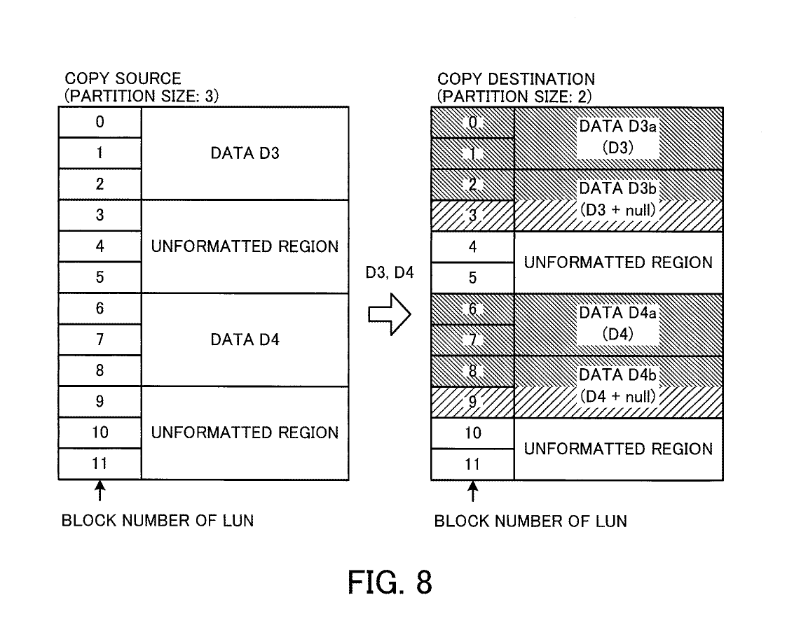

In the following, a further description will be given of the functions of the copy control unit 134 with reference to FIGS. 7 and 8. FIG. 7 illustrates an example of a copy process (partition size of copy source<partition size of copy destination) according to the second embodiment. FIG. 8 illustrates an example of a copy process (partition size of copy source>partition size of copy destination) according to the second embodiment.

The example of FIG. 7 illustrates a copy method that is used when copying data D1 and data D2 stored in a copy source LUN area to a copy destination LUN area. Each LUN area includes a plurality of partitions, and each partition includes a plurality of blocks of the LUN area. The copy source LUN area includes 6 partitions each having a partition size of 2 (that is, each partition having a size of 2 blocks). On the other hand, the copy destination LUN area includes 4 partitions each having a partition size of 3 (that is, each partition having a size of 3 blocks).

A partition assigned to the block numbers 0 and 1 of the copy source LUN area stores data D1. A partition assigned to the block numbers 2 and 3, a partition assigned to the block numbers 4 and 5, a partition assigned to the block numbers 6 and 7, and a partition assigned to the block numbers 10 and 11 are unformatted. A partition assigned to the block numbers 8 and 9 stores data D2.

The copy destination LUN area includes a partition assigned to the block numbers 0, 1, and 2, a partition assigned to the block numbers 3, 4, and 5, a partition assigned to the block numbers 6, 7, and 8, and a partition assigned to the block numbers 9, 10, and 11. When the data D1 and data D2 have not been copied by the copy control unit 134, all of these partitions are unformatted. The copy control unit 134 copies the data D1 and data D2 to blocks with the same numbers.

When copying the data D1, the copy control unit 134 specifies block numbers of the copy destination in which the data D1 is to be stored. Further, the copy control unit 134 specifies a partition including the specified block numbers. In the example of FIG. 7, the partition assigned to the block numbers 0, 1, and 2 is specified. Further, the copy control unit 134 specifies a block number of a region that remains unformatted if the data D1 is stored in the specified partition. Then, the copy control unit 134 adds null data to the data D1 such that the region corresponding to the block number is filled with null data.

In the example of FIG. 7, if the data D1 is copied as-is, a region of the copy destination corresponding to the block number 2 remains unformatted. Accordingly, the copy control unit 134 creates data D1a by adding null data for one block to the end of the data D1. Then, the copy control unit 134 writes the data D1a to the copy destination LUN area. In this step, the copy control unit 134 also writes a BCC calculated for data D1a to the LUN area.

When copying the data D2, the copy control unit 134 specifies block numbers of the copy destination in which the data D2 is to be stored. Further, the copy control unit 134 specifies a partition including the specified block numbers. In the example of FIG. 7, the partition assigned to the block numbers 6, 7, and 8, and the partition assigned to the block numbers 9, 10, and 11 are specified.

Further, the copy control unit 134 specifies a block number of a region that remains unformatted if the data D2 is stored in the specified partitions. Then, the copy control unit 134 adds null data to the data D2 such that the region corresponding to the block number is filled with null data. In this example, since two partitions are specified, the copy control unit 134 creates data with null data added (data D2a, data D2b) for each partition.

In the example of FIG. 7, if a portion of the data D2 corresponding to the block number 8 is copied as-is, a region corresponding to the block numbers 6 and 7 in the partition of the copy destination including the block number 8 remains unformatted. Further, if a portion of the data D2 corresponding to the block number 9 is copied as-is, a region corresponding to the block numbers 10 and 11 in the partition of the copy destination including the block number 9 remains unformatted.

Accordingly, the copy control unit 134 creates the data D2a by adding null data for two blocks to the front of the portion of the data D2 corresponding to the block number 8. Further, the copy control unit 134 creates the data D2b by adding null data for two blocks to the end of the portion of the data D2 corresponding to the block number 9. Then, the copy control unit 134 writes the data D2a and data D2b to the copy destination LUN area. In this step, the copy control unit 134 also writes a BCC calculated for each of the data D2a and data D2b to the LUN area.

The above has described the case where the partition size of the copy source is smaller than the partition size of the copy destination. The same applies to the case where the partition size of the copy source is greater than the partition size of the copy destination.

The example of FIG. 8 illustrates a copy method that is used when copying data D3 and data D4 stored in a copy source LUN area to a copy destination LUN area. The copy source LUN area includes 4 partitions each having a partition size of 3 (that is, each partition having a size of 3 blocks). On the other hand, the copy destination LUN area includes 6 partitions each having a partition size of (that is, each partition having a size of 2 blocks).

The copy source LUN area includes a partition assigned to the block numbers 0, 1, and 2, a partition assigned to the block numbers 3, 4, and 5, a partition assigned to the block numbers 6, 7, and 8, and a partition assigned to the block numbers 9, 10, and 11.

The partition assigned to the block numbers 0, 1, and 2 of the copy source LUN area stores data D3. The partition assigned to the block numbers 6, 7, and 8 stores data D4. The partition assigned to the block numbers 3, 4, and 5 and the partition assigned to the block numbers 9, 10, and 11 are unformatted.

The copy destination LUN area includes a partition assigned to the block numbers 0 and 1, a partition assigned to the block numbers 2 and 3, a partition assigned to the block numbers 4 and 5, a partition assigned to the block numbers 6 and 7, a partition assigned to the block numbers 8 and 9, and a partition assigned to the block numbers 10 and 11. When the data D3 and data D4 have not been copied by the copy control unit 134, all of these partitions are unformatted. The copy control unit 134 copies the data D3 and data D4 to blocks with the same numbers.

When copying the data D3, the copy control unit 134 specifies block numbers of the copy destination in which the data D3 is to be stored. Further, the copy control unit 134 specifies a partition including the specified block numbers. In the example of FIG. 8, the partition assigned to the block numbers 0 and 1, and the partition assigned to the block numbers 2 and 3 are specified.

Further, the copy control unit 134 specifies a block number of a region that remains unformatted if the data D3 is stored in the specified partitions. Then, the copy control unit 134 adds null data to the data D3 such that the region corresponding to the block number is filled with null data. In this example, since two partitions are specified, the copy control unit 134 creates, for each partition, data (data D3a, data D3b) with a size that matches the size of the partition, by adding null data as needed.

In the example of FIG. 8, if the data D3 is copied as-is, a region of the copy destination corresponding to the block number 3 remains unformatted. Accordingly, the copy control unit 134 creates the data D3a corresponding to the first two blocks of the data D3, and also creates the data D3b by adding null data for one block to the end of the last one block of the data D3. Then, the copy control unit 134 writes the data D3a and data D3b to the copy destination LUN area. In this step, the copy control unit 134 also writes a BCC calculated for each of the data D3a and data D3b to the LUN area.

When copying the data D4, the copy control unit 134 specifies block numbers of the copy destination in which the data D4 is to be stored. Further, the copy control unit 134 specifies a partition including the specified block numbers. In the example of FIG. 8, the partition assigned to the block numbers 6 and 7, and the partition assigned to the block numbers 8 and 9 are specified.

In this case, as in the case of copying the data D3, the copy control unit 134 creates data D4a corresponding to the first two blocks of the data D4, and also creates data D4b by adding null data for one block to the end of the last one block of the data D4. Then, the copy control unit 134 writes the data D4a and data D4b to the copy destination LUN area. In this step, the copy control unit 134 also writes a BCC serving as an error checking code calculated for each of the data D4a and data D4b to the LUN area.

As described above, the copy control unit 134 directly writes data to an unformatted partition, by adding null data to fit the size of the partition. In this step, the copy control unit 134 calculates a BCC for the data to be written to the partition, and writes the data together with the BCC. Thus, the consistency between the data stored in the partition and the BCC is maintained. Accordingly, it is possible to successfully complete a READ process and a WRITE process after writing data, without performing formatting in advance.

According to the method described above, writing of data and formatting of an unformatted region remaining in each partition are completed by a single write process, and therefore the processing load is increased very little. Further, since there is no need to perform formatting before starting operations, it is possible to reduce the time taken to start operations. Further, unlike the case where the entire LUN area is formatted in the background at one time, it is possible to prevent adverse effects on other processes due to an increase in processing load during operations.

For convenience of explanation, the example has been described in which data is copied between LUN areas. However, the cache control unit 135 performs the same processing when writing data to an unformatted partition. That is, when writing data from the cache memory to a LUN area, the cache control unit 135 generates data with null data added to fit the destination partition as needed. Further, the cache control unit 135 calculates a BCC of the generated data and writes the BCC to the LUN area together with the data.

The above is a description of the functions of the controller 111.

According to the functions of the controller 111 described above, it is possible to increase the speed and efficiency of processes during normal operations, and also to increase the speed of processes performed on formatted partitions, such as a RAID rebuilding process and the like in case of failure. That is, according to the functions of the controller 111 described above, only a partition to which data is written is formatted, therefore the area subjected to rebuilding is reduced. Accordingly, it is possible to complete recovery in a short time. Further, the number of times data is written to each partition is reduced. Thus, in the case where a device such as an SSD and the like having a limited number of writes is used, its service life may be extended.

(2-4) Process Flow

In the following, the flow of processes performed by the controller 111 will be described.

LUN Creation

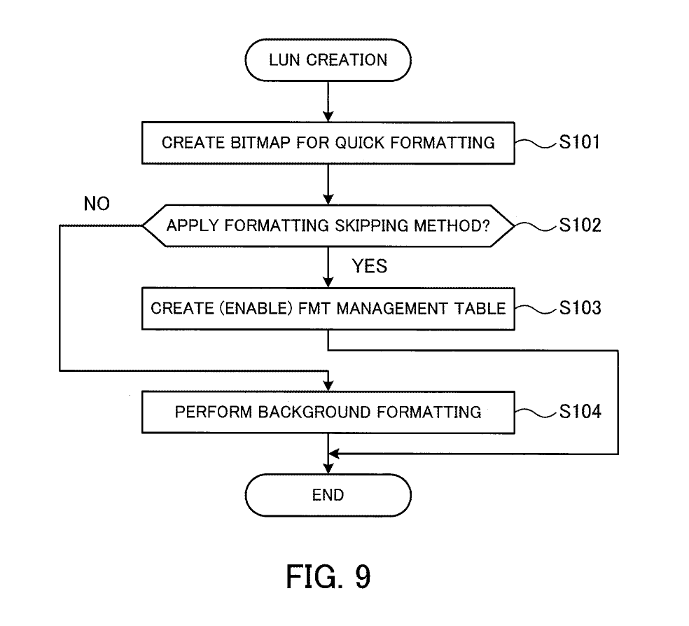

First, the flow of a process for creating a LUN area (LUN creation process) will be described with reference to FIG. 9. FIG. 9 is a flowchart illustrating the flow of an LUN creation process according to the second embodiment. This process is mainly executed by the RAID control unit 133.

(S101) The RAID control unit 133 creates a bitmap for quick formatting. The RAID control unit 133 having created the bitmap discloses a LUN to the servers 101a and 101b via the FCP/NAS control unit 132.

Quick formatting is a method that writes null data and a BCC to (that is, initializes) a sector of an HDD in the background. The controller 111 is accessed by the servers 101a and 101b even during initialization. Accordingly, in order to manage the progress of the initialization, a bitmap in which each bit indicates the progress is used.

(S102) The RAID control unit 133 determines whether to apply a formatting skipping method. The formatting skipping method is a method that directly writes write data to an unformatted region without performing formatting as illustrated in FIGS. 7 and 8.

The user sets in advance whether to apply the formatting skipping method, and information indicating the settings is stored in the storage unit 131. The RAID control unit 133 determines whether to apply the formatting skipping method by referring to this information. If the formatting skipping method is applied, the process proceeds to step S103. On the other hand, if the formatting skipping method is not applied, the process proceeds to step S104.

(S103) The RAID control unit 133 creates an FMT management table 131b and stores the FMT management table 131b in the storage unit 131. In this step, as illustrated in FIG. 6 (initial state), the RAID control unit 133 creates a bitmap in which all the bits have a bit value (1 in the example of FIG. 6) indicating an unformatted state as an FMT management table 131b. When the FMT management table 131b is stored in the storage unit 131, the formatting skipping method is enabled. When the operation of step S103 completes, a series of operations illustrated in FIG. 9 ends.

(S104) The RAID control unit 133 performs background formatting (that is, quick formatting). For example, when the controller 111 receives an access request from the server 101a or 101b, the RAID control unit 133 initializes the area to be accessed, and reports completion of the initialization to the cache control unit 135. Upon receiving the report, the cache control unit 135 performs a process corresponding to the access request. When the operation of step S104 completes, a series of operations illustrated in FIG. 9 ends.

The above is a description of the flow of the LUN creation process.

WRITE

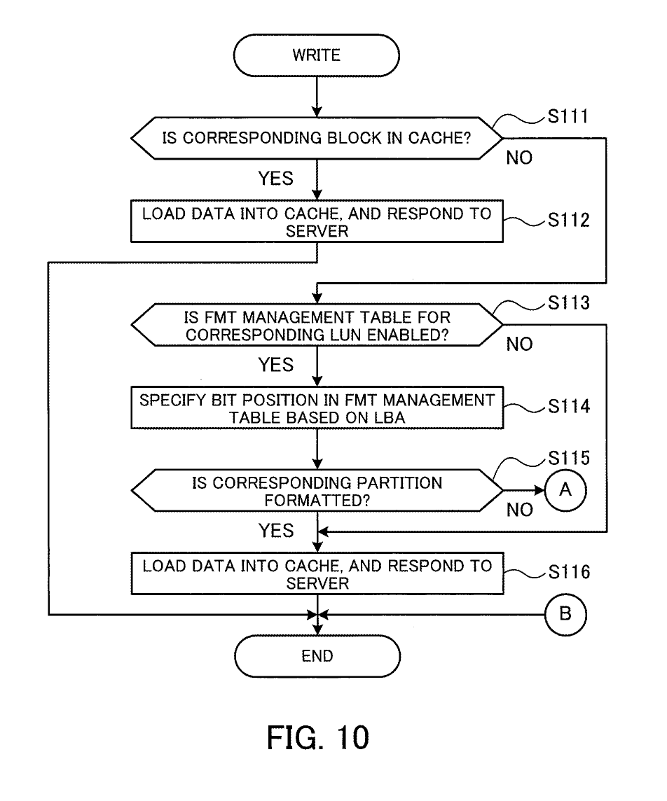

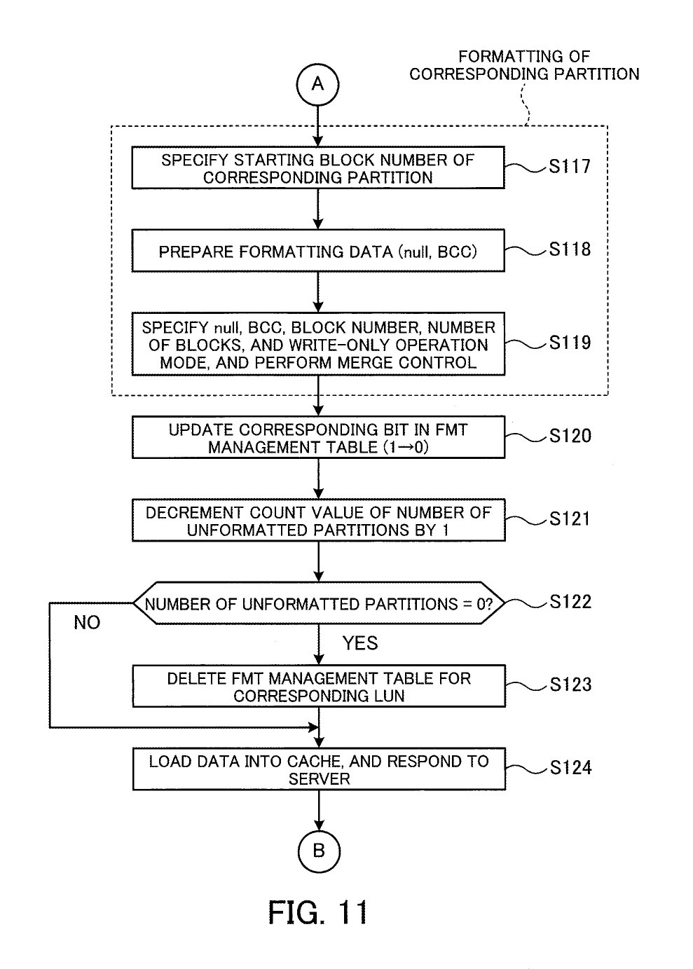

In the following, the flow of a WRITE process will be described with reference to FIGS. 10 and 11. FIG. 10 is a first flowchart illustrating the flow of a WRITE process according to the second embodiment. FIG. 11 is a second flowchart illustrating the flow of the WRITE process according to the second embodiment.

This process is mainly executed by the cache control unit 135. For convenience of explanation, the following describes an example in which the controller 111 has received a WRITE request from the server 101a.

(S111) The cache control unit 135 determines whether a block (a corresponding block) specified in a WRITE request is in the cache. That is, the cache control unit 135 determines whether data of the corresponding block is stored in the cache memory. If the corresponding block is in the cache, the process proceeds to step S112. On the other hand, if the corresponding block is not in the cache, the process proceeds to step S113.

(S112) The cache control unit 135 loads the data into the cache, and responds to the server 101a. That is, the cache control unit 135 stores write data that is the subject of the WRITE process in the corresponding block in the cache memory, and transmits a completion response indicating completion of writing, to the server 101a via the FCP/NAS control unit 132. Note that the cache control unit 135 writes the data stored in the cache memory to an HDD of the RAID group 112 upon a predetermined event. When the operation of step S112 completes, a series of operations illustrated in FIGS. 10 and 11 ends.

(S113) The cache control unit 135 determines whether an FMT management table 131b corresponding to a LUN (a corresponding LUN) of a LUN area including the corresponding block is enabled. That is, the cache control unit 135 determines whether an FMT management table 131b for the corresponding LUN is stored in the storage unit 131. If the FMT management table 131b for the corresponding LUN is enabled, the process proceeds to step S114. On the other hand, if the FMT management table 131b for the corresponding LUN is not enabled, the process proceeds to step S116.

(S114) The cache control unit 135 specifies a bit position in the FMT management table 131b corresponding to a location to which data is to be written, based on a logical block addressing (LBA) specified in the WRITE request. That is, the cache control unit 135 specifies a bit indicating the formatting status of a partition (a corresponding partition) including the corresponding block, from the FMT management table 131b.

(S115) The cache control unit 135 determines whether the corresponding partition is formatted, by referring to the bit value of the specified bit. If the corresponding partition is formatted, the process proceeds to step S116. On the other hand, if the corresponding partition is unformatted, the process proceeds to step S117 of FIG. 11.

(S116) The cache control unit 135 loads the data into the cache, and responds to the server 101a. That is, the cache control unit 135 stores write data that is the subject of the WRITE process in the corresponding block in the cache memory, and transmits a completion response indicating completion of writing, to the server 101a via the FCP/NAS control unit 132. Note that the cache control unit 135 writes the data stored in the cache memory to an HDD of the RAID group 112 upon a predetermined event. When the operation of step S116 completes, a series of operations illustrated in FIGS. 10 and 11 ends.

(S117) The cache control unit 135 specifies a starting block number of the corresponding partition.

(S118) The cache control unit 135 prepares formatting data (null data and its BCC).

(S119) The cache control unit 135 specifies the null data, the BCC, the block number, the number of blocks, and a WRITE-only operation mode, and performs merge control. The merge control is a process that adds null data to the write data in accordance with the size of a corresponding partition as needed, and calculates a BCC based on the write data with the null data added.

The WRITE-only operation mode is an operation mode in which write data is immediately written to a corresponding partition, without reading old data and its BCC written in the corresponding partition. Similar to the examples of FIGS. 7 and 8, the cache control unit 135 adds null data to the front or the end of data specified in the WRITE request as needed so as to generate new write data, and writes the new write data to the corresponding partition, together with a BCC calculated for the new write data.

(S120) The cache control unit 135 updates a bit (a corresponding bit) in the FMT management table 131b for the corresponding partition. With the operations in steps S117 through 5119, the corresponding partition is substantially formatted. Thus, the cache control unit 135 changes the bit value of the corresponding bit to a value (0, for example) indicating a formatted state.

(S121) The cache control unit 135 decrements the number of unformatted partitions (the count value indicating how many partitions are unformatted) by 1, in the information recorded in the LUN management table 131a.

(S122) The cache control unit 135 determines whether the number of unformatted partitions is 0. If the number of unformatted partitions is 0, the process proceeds to step S123. On the other hand, if the number of unformatted partitions is not 0, the process proceeds to step S124. Note that when the number of unformatted partitions is 0, it indicates that the entire LUN area of the corresponding LUN is formatted.

(S123) The cache control unit 135 deletes the FMT management table 131b for the corresponding LUN. That is, when the entire LUN area is formatted, the cache control unit 135 deletes the FMT management table 131b indicating the formatting status of the LUN area, thereby increasing the free space in the storage unit 131.

(S124) The cache control unit 135 loads the data into the cache, and responds to the server 101a. That is, the cache control unit 135 stores write data that is the subject of the WRITE process in the corresponding block in the cache memory, and transmits a completion response indicating completion of writing, to the server 101a via the FCP/NAS control unit 132. Note that the cache control unit 135 writes the data stored in the cache memory to an HDD of the RAID group 112 upon a predetermined event. When the operation of step S124 completes, a series of operations illustrated in FIGS. 10 and 11 ends.

The above is a description of the flow of the WRITE process.

READ

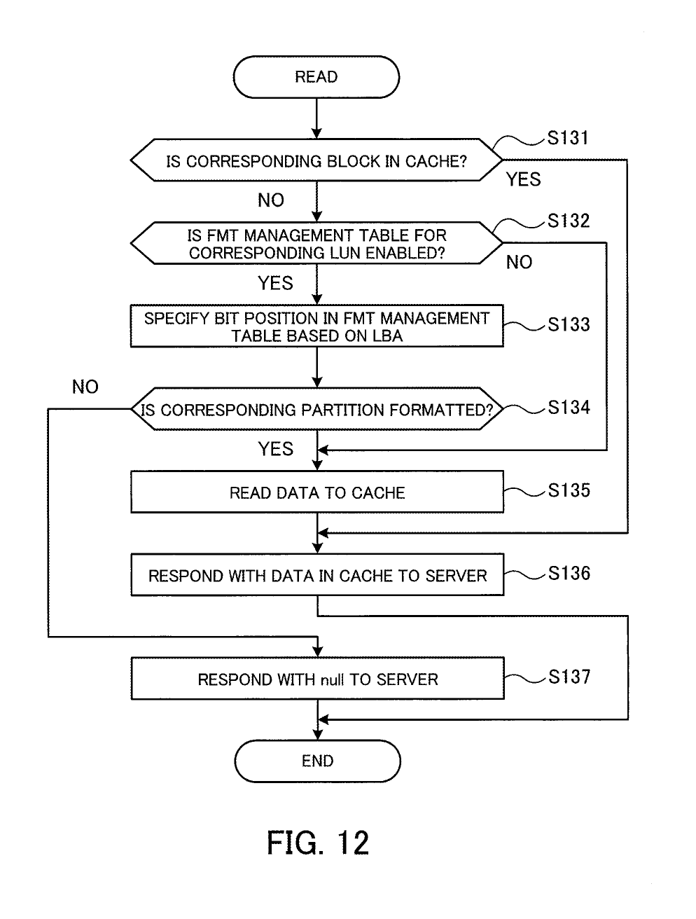

In the following, the flow of a READ process will be described with reference to FIG. 12. FIG. 12 is a flowchart illustrating the flow of a READ process according to the second embodiment. This process is mainly executed by the cache control unit 135. For convenience of explanation, the following describes an example in which the controller 111 has received a READ request from the server 101a.

(S131) The cache control unit 135 determines whether a block (a corresponding block) specified in a READ request is in the cache. That is, the cache control unit 135 determines whether data of the corresponding block is stored in the cache memory. If the corresponding block is in the cache, the process proceeds to step S136. On the other hand, if the corresponding block is not in the cache, the process proceeds to step S132.

(S132) The cache control unit 135 determines whether an FMT management table 131b for a LUN (a corresponding LUN) of a LUN area including the corresponding block is enabled. That is, the cache control unit 135 determines whether an FMT management table 131b for the corresponding LUN is stored in the storage unit 131. If the FMT management table 131b for the corresponding LUN is enabled, the process proceeds to step S133. On the other hand, if the FMT management table 131b for the corresponding LUN is not enabled, the process proceeds to step S135.

(S133) The cache control unit 135 specifies a bit position in the FMT management table 131b corresponding to a location from which data is to be read, based on an LBA specified in the READ request. That is, the cache control unit 135 specifies a bit indicating the formatting status of a partition (a corresponding partition) including the corresponding block, based on the FMT management table 131b.

(S134) The cache control unit 135 determines whether the corresponding partition is formatted, by referring to the bit value of the specified bit. If the corresponding partition is formatted, the process proceeds to step S135. On the other hand, if the corresponding partition is unformatted, the process proceeds to step S137.

(S135) The cache control unit 135 reads data from the corresponding block to the cache memory.

(S136) The cache control unit 135 responds with the read data to the server 101a. When the operation of step S136 completes, a series of operations illustrated in FIG. 12 ends.

(S137) The cache control unit 135 responds with null data to the server 101a. When the operation of step S137 completes, a series of operations illustrated in FIG. 12 ends.

The above is a description of the flow of the READ process.

(2-5) Applications

In the following, a description will be given of applications of the technique according to the second embodiment described above. Note that although a background copy method, a copy-on-write method, and a mirror breaking method will be described below as examples, the range of application of the present technique is not limited to these examples.

OPC/QuickOPC

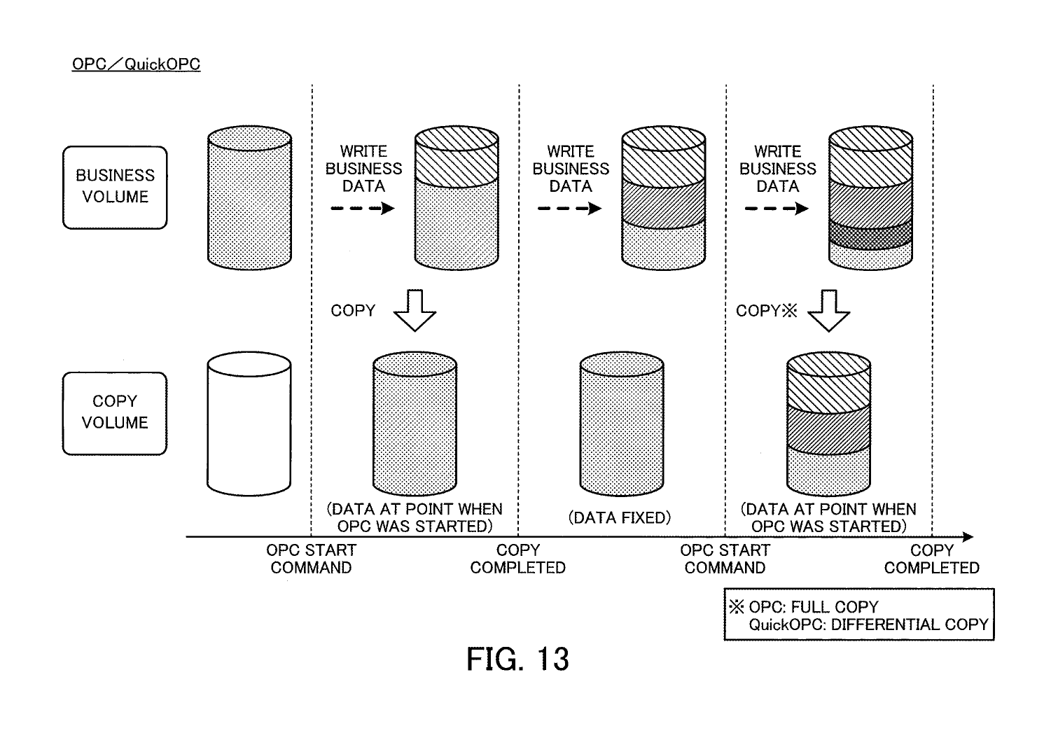

First, a description will be given of a method called One Point Copy (OPC)/QuickOPC (a background copy method) with reference to FIG. 13. FIG. 13 is an explanatory diagram illustrating application to OPC/QuickOPC.

OPC is a function that copies a continuous block region of a copy source LUN area to a different LUN area (copy destination) at a point in time. For example, as illustrated in FIG. 13, this function may be used to copy data from a business volume serving as a business storage area to a copy volume serving as a backup storage area. In this example, a business volume before issuance of a start command is copied to a copy volume.

OPC has two copy modes: logical copy and physical copy. In the logical copy mode, in response to a copy request from the server 101a or 101b, logical copying is completed before performing physical copying, and a report indicating the completion is returned to the server 101a or 101b. On the other hand, in the physical copy mode, physical copying is performed in an HDD after completion of logical copying. OPC is executed in the background.

QuickOPC has the same mechanism as OPC that copies a continuous block region at a point in time.

However, in the second and subsequent copy operations after completion of the first copy operation, QuickOPC copies only an updated block that includes data different from data included at the time of execution of the previous copy operation. In the first copy operation, the entire area is physically copied. In the second and subsequent copy operations, the changes from the previous copy operation are physically copied.

In the case where the technique of the second embodiment is applied, the copy source LUN area may include an unformatted region. Thus, data in a formatted region is subjected to physical copying. As for the copy destination LUN area, the entire area is an unformatted area, or the area is an unformatted area that is set upon execution of OPC or QuickOPC.

Logical Copy

When OPC is started, the copy control unit 134 generates a bitmap (transfer bitmap) representing the copy status. In the transfer bitmap, the bit value indicates whether data in a block region has been copied. When the transfer bitmap is generated, the copy control unit 134 completes the logical copying.

The copy control unit 134 generates, in the copy destination area, data having the same content as the data stored in the copy source area at the time of completion of the logical copying, by performing copy monitoring using the transfer bitmap and exclusive control with respect to host I/Os.

When QuickOPC is started, the copy control unit 134 generates a transfer bitmap and a bitmap (differential bitmap) representing the update status. In the differential bitmap, the bit value indicates whether a block region is updated. When the transfer bitmap and the differential bitmap are generated, the copy control unit 134 completes the initial logical copying.

The copy control unit 134 changes the status of the unformatted region of the copy source to “copy completed”. Thus, it is possible to reduce the area to be copied. Note that, in the case where the partition size differs between the copy source LUN area and the copy destination LUN area, the copy control unit 134 changes the status of the area adjusted to the partition size of the copy destination to “copy completed” (see FIGS. 7 and 8).

Physical Copy

After completion of logical copying, the copy control unit 134 sequentially physically copies data from the copy source area to the copy destination area. Then, the copy control unit 134 changes the bit value of the transfer bitmap corresponding to the area that is physically copied to the value indicating “copy completed”.

Writing to the copy destination starts with writing data read from the copy source to the cache memory. The copy control unit 134 prepares initialization data (null data and a BCC) for the size of a corresponding partition and merges the data to be written with the initialization data. Further, the copy control unit 134 writes the data to an HDD upon a predetermined event (for example, when the amount of write data exceeds a threshold, when there is no host I/O for a certain period of time, when write data resides in the cache memory for a certain period of time or longer, or in some other events).

In the case of OPC, when the entire LUN area is physically copied, the copy control unit 134 deletes a bitmap indicating the formatting status and releases the storage area. In the case of QuickOPC, even when the entire LUN area is physically copied, the copy control unit 134 retains the bitmap for tracking. Note that the transfer bitmap representing the copy status is retained.

In QuickOPC, after completion of initial logical copying, if a WRITE process occurs in the copy source area and the copy destination area, information on updated locations is held in the differential bitmap. After completion of initial logical copying, if a WRITE request occurs to an uncopied region of the copy source, data is immediately copied to the copy destination before a WRITE process, and then the WRITE request is processed. In this case, the bit value of the corresponding area in the transfer bitmap is changed to “copy completed”, and the bit value in the differential bitmap is changed to “updated”.

Further, in QuickOPC, if a command for restarting an already started QuickOPC session is received from the host computer, the copy control unit 134 copies the updated portion indicated in the differential bitmap to the copy destination. With these control operations, there is no need to perform physical formatting of the copy destination in advance, which makes it possible to save time. Further, when there is an unformatted region in the copy source, only the data in a formatted region is transferred. This may save time and reduce the processing load.

SnapOPC/SnapOPC+

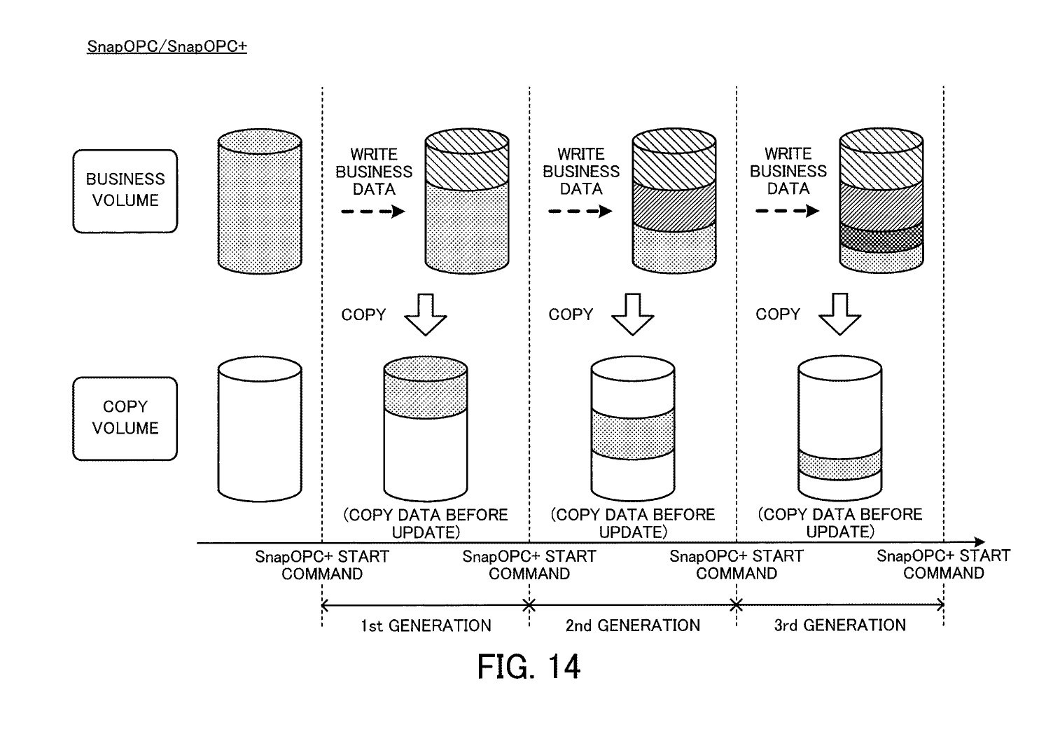

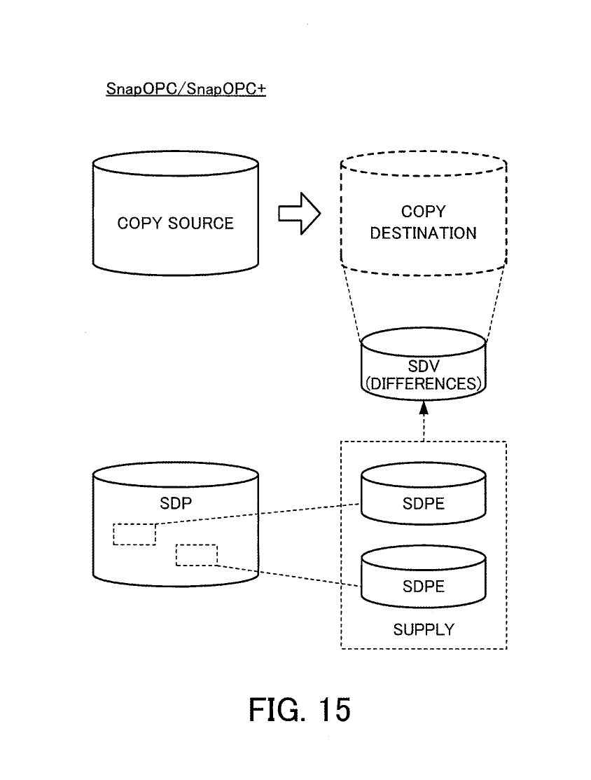

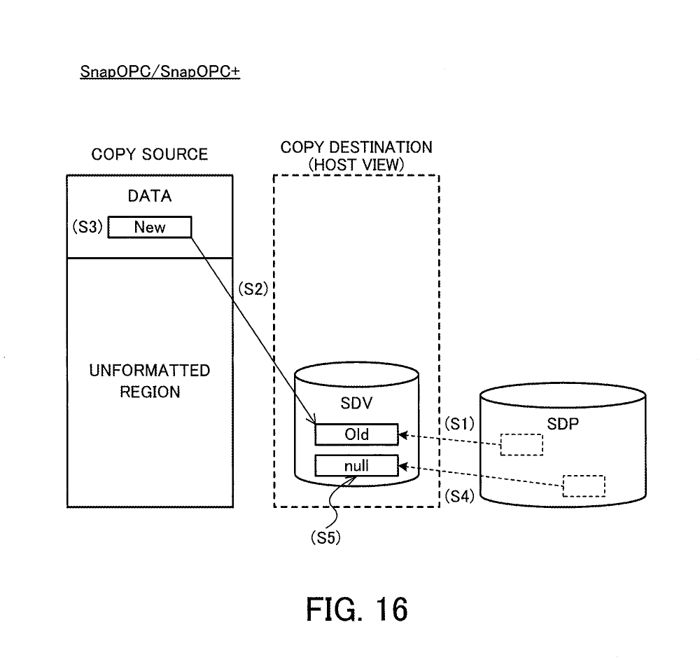

In the following, a description will be given of application to a method called SnapOPC/SnapOPC+(a copy-on-write method) with reference to FIGS. 14 through 16. FIG. 14 is a first explanatory diagram illustrating application to SnapOPC/SnapOPC+. FIG. 15 is a second explanatory diagram illustrating application to SnapOPC/SnapOPC+. FIG. 16 is a third explanatory diagram illustrating application to SnapOPC/SnapOPC+.

SnapOPC is a function that logically copies a continuous block region of a LUN area (copy source) as a block region of a different LUN area (copy destination) at a point in time. However, unlike OPC/QuickOPC, SnapOPC moves data before update, from an updated block to the copy destination. The copy destination LUN area of data recognized by the host computer is reproduced by a combination of a copy source block region that is not updated and the data before the update in the updated copy source block region.

For example, as illustrated in FIG. 14, this function may be used to copy data before update, from a business volume serving as a business storage area to a copy volume serving as a backup storage area. In this example, among data stored in the business volume before issuance of a start command, data before issuance of the start command corresponding to an area that is updated in the business volume after issuance of the start command is copied to the copy volume.

In SnapOPC/SnapOPC+, the area reserved in the copy destination only needs to have a capacity sufficient to hold an updated portion of data. Further, in SnapOPC/SnapOPC+, every time the copy source is updated, old data is physically copied to the copy destination.

SnapOPC+is a version of SnapOPC, improved by providing a mechanism for enabling generation management of updated portions. According to this mechanism, instead of holding redundant data as in the case of SnapOPC, the generation of data is managed as an update history. Therefore, it is possible to backup data of each generation with a smaller copy destination area. Further, since it is possible to manage the generation of the differences from the updated data as an update history, it is also possible to create a generation backup with smaller disk space compared to a regular backup using SnapOPC.

In the case where the formatting skipping method is employed, the copy source area may include an unformatted region. The copy destination area is a LUN area, and no actual data is assigned at first. Thus, when a copy source block region is updated, a predetermined area is taken and assigned from a separately provided storage pool including multiple LUN areas as needed (see FIG. 15).

For example, the unit of the area size assigned as a copy destination area is often selected from 1 GB, 2 GB, 4 GB, and so on. However, in the case where the formatting skipping method is employed for a LUN area included in a storage pool, the area size is adjusted to a multiple of the partition size of the LUN area.

If an update occurs in a formatted partition, data before the update is moved from an updated block to the copy destination (see FIG. 16). If a write occurs in an unformatted partition, no actual data exists in the unformatted partition before update. However, in SnapOPC/SnapOPC+, the copy destination LUN area recognized from the server is reproduced by a combination of a copy source block that is not updated and the data before the update in the updated copy source block.

Accordingly, the copy control unit 134 writes null data, as data before the update, to the copy destination block. The copy control unit 134 writes null data for a block subjected to a WRITE process to the copy destination block. In this step, the copy control unit 134 merges data to be copied and the initialization data in the cache, and writes the merged data. A WRITE process with respect to the copy source area is performed in the same manner.

In the case where the first WRITE request is issued with respect to a an unformatted partition in the copy source and then the next WRITE request is issued with respect to the partition subjected to initialization, the copy control unit 134 obtains data (null data) of a block before the update by performing cache control, and writes the data to the copy destination. When writing to an HDD is completed and null data is not present in the cache, the copy control unit 134 reads data (null data) in a block before the update from the HDD, and writes the data to the destination of update.

As described above, in the case where the formatting skipping method is applied to a LUN area of a storage pool, there is no need to perform physical formatting of the LUN area in advance, which makes it possible to save time. Further, when a WRITE process with respect to an unformatted partition occurs continuously, it is highly likely that data before update (null data) is hit in the cache. This reduces the time needed to perform a WRITE process for writing data before update (null data) to the copy destination area.

EC

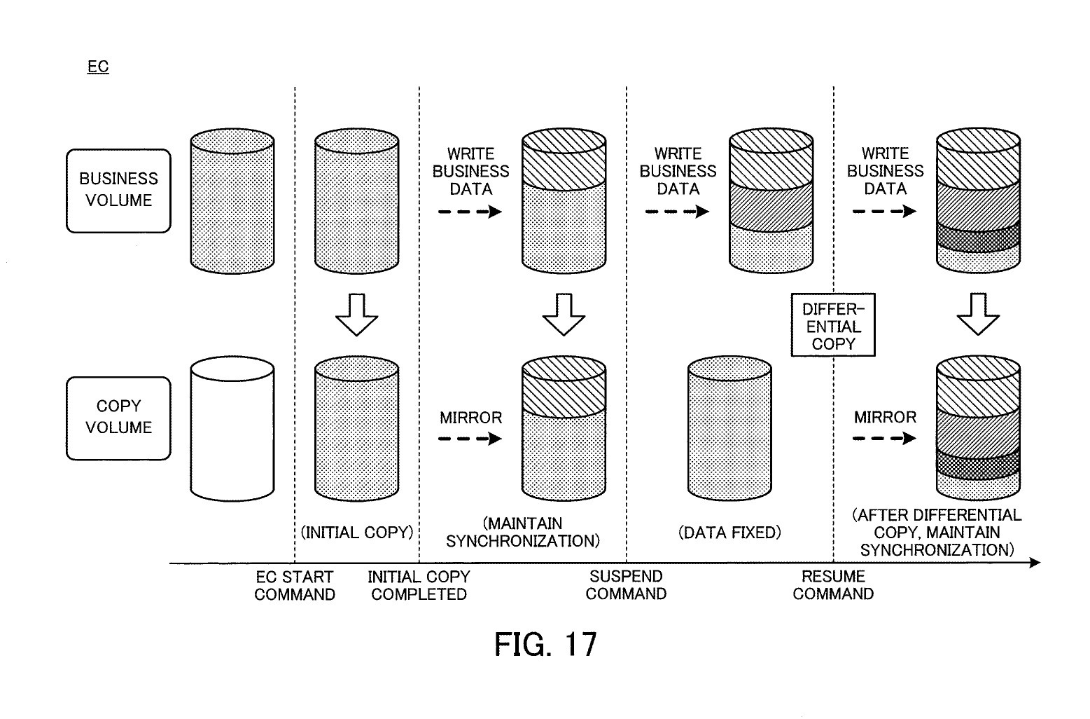

In the following, a description will be given of application to a method called Equivalent Copy (EC) (a mirror breaking method) with reference to FIG. 17. FIG. 17 is an explanatory diagram illustrating application to EC.

EC is a technique that copies a continuous block region (copy source) of a LUN area to a block region (copy destination) of a different LUN area to establish synchronization between the copy source area and the copy destination area, and creates a copy by detaching the synchronized areas from each other. Further, EC has a mechanism that suspends and resumes synchronization (see FIG. 17) using a suspend command and a resume command. When synchronization is resumed, the differences resulting from updating the copy source during the suspension of synchronization are reflected to the copy destination.

In the case where the formatting skipping method is employed, the copy source area may include an unformatted region. A formatted region is subjected to the initial copying. As for the copy destination area, the entire area is set in an unformatted area, or the area is dynamically set in an unformatted area upon execution of EC. Note that in the case where the size of the partition to be initialized differs between the copy source LUN area and the copy destination LUN area, the size is adjusted by adding null data as in the case of SnapOPC/OPC+(see FIGS. 7 and 8).

When performing writing to a copy destination area, the copy control unit 134 writes data read from a copy source area to a cache memory of a copy destination system. In doing so, the copy control unit 134 prepares initialization data for the corresponding partition in the cache memory, and merges the data to be copied. Then, the copy control unit 134 writes the cached data to an HDD of the copy destination upon a predetermined event.

In the case of EC, if a WRITE request is received from a server while maintaining synchronization, a WRITE process is performed on both the two synchronized areas. In the case where the formatting skipping method is employed, if a WRITE request is issued to an unformatted partition while establishing synchronization or while maintaining synchronization, the copy control unit 134 writes the data merged with initialization data to both the synchronized areas.

When a suspend command is issued, synchronization is suspended, or the synchronized areas are detached. Thus, the two synchronized areas become accessible independently of each other in different operations. The update status of LUN areas of the copy source and LUN areas of the copy destination is managed in a bitmap. When a resume command is issued, synchronization is resumed. Then, the differences from the updated data are reflected to the LUN area of the copy destination.

In the case where the formatting skipping method is employed, there is no need to perform physical formatting of the copy destination in advance, which makes it possible to save time. Further, since only the data in the area excluding the unformatted partitions is initially transferred upon establishing synchronization, it is possible to reduce the amount of data, and to reduce the processing load for transfer.

Modifications

According to one modification, there is provided a method that performs physical formatting of a LUN area as a background job so as to perform physical formatting in units of partitions while determining unformatted partitions.

In the modification described above, when an I/O (a host I/O, an I/O associated with execution of the copy function, or the like) to a corresponding LUN area occurs, the controller 111 suspends the background job. After that, if no I/O to the corresponding LUN area occurs for a predetermined period of time, the controller 111 resumes the background job. Then, the controller 111 physically formats unformatted partitions successively, while determining unformatted partitions by referring to the FMT management table 131b.

In another modification, the cache control unit 135 may perform cache control that delays writing to a corresponding partition such that the corresponding partition is filled with data other than null data in one write operation. According to this modification, since there are more opportunities to directly write data other than null data to an unformatted region, it is possible to more effectively reduce the processing load.

The above is a description of the flow of processes performed by the controller 111.

According to the operations of the controller 111 described above, not only an increase in the speed and efficiency of processes during normal operations, but also an increase in the speed of processes performed on formatted partitions, such as a RAID rebuild process and the like in case of failure, may be achieved. That is, according to the operations of the controller 111 described above, only a partition to which data is written is placed into a formatted state, therefore the area subjected to rebuilding is reduced. Accordingly, it is possible to complete recovery in a short time. Further, the number of times data is written to each partition is reduced. Thus, in the case where a device such as an SSD and the like having a limited number of writes is used, its service life may be extended.

The above is a description of the second embodiment.

According to the present disclosure, it is possible to efficiently place an unformatted region in an available state.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage control apparatus comprising:
a memory configured to store management information indicating a formatting status of each of a plurality of partitions included in a storage area; and
a processor configured to perform a procedure including:
upon receiving a write request to write first data to the storage area, determining whether a partition of the plurality of partitions that includes a region to which the first data is to be written is formatted, based on the management information, and
when the partition is unformatted, generating third data with a size that matches a size of the partition by combining the first data and predetermined second data, and writing the third data to the partition.

2. The storage control apparatus according to claim 1, wherein the procedure further includes calculating an error checking code for the third data based on the generated third data, and writing the error checking code together with the third data.

3. The storage control apparatus according to claim 1, wherein the generating includes generating the third data by combining the first data and the second data such that, in the partition including the region to which the first data is to be written, a region other than the region to which the first data is to be written is filled with the second data.

4. The storage control apparatus according to claim 1, wherein the procedure further includes:
upon receiving a read request to read data from the storage area, determining whether a partition of the plurality of partitions that includes a region from which the data is to be read is formatted, based on the management information; and
when the partition is unformatted, responding with the second data to the read request.

5. The storage control apparatus according to claim 1, wherein the procedure further includes changing a formatting status of the partition of the plurality of partitions to which the third data is written to a formatted state, in the management information.

6. The storage control apparatus according to claim 1, wherein the procedure further includes deleting the management information when the management information indicates that the formatting status of all the plurality of partitions is a formatted state.
